(19) United States
(12) Patent Application Publication
(10) Pub. No.: US 2020/0193474 A1
(43) Pub. Date: Jun. 18, 2020

(54) VISUAL CONTENT DISPLAY SYSTEM AND METHOD

(71) Applicant: Jeffrey Jackson, Fennimore, WI (US)

(72) Inventor: Jeffrey Jackson, Fennimore, WI (US)

(21) Appl. No.: 16/719,231

(22) Filed: Dec. 18, 2019

Related U.S. Application Data
(60) Provisional application No. 62/777,319, filed on Dec. 10, 2018.

(51) Int. Cl. G06Q 30/02; H04N 7/18; H04L 29/06

(52) U.S. Cl. CPC G06Q 30/0251; H04L 67/42; H04N 7/183

(57) ABSTRACT

A visual content display system and a method are provided for displaying visually informative content remotely received over a network. The visual content display system includes a display device, database, server, and controller. The display device displays visual content. The display device includes a wireless transceiver and universal mounting hardware. The wireless transceiver establishes a communication with a network to display the visual content received from electronic devices operably connected over the network. The universal mounting hardware secures the display device to objects. The database stores data pertaining to the visual content. The server provides information pertaining to the visual content in response to a request received from a user over the network. The controller provides the data pertaining to the visual content to the server from the database. The server provides the visual content information to be displayed through the display device over the network.

### CROSS-REFERENCE TO RELATED APPLICATIONS

The present application claims the priority of the Provisional Patent Application (PPA) with Ser. No. 62/777,319 filed on Dec. 10, 2018 with the title “ADVERTISING DISPLAY SYSTEM”. The contents of the above-mentioned PPA are herein incorporated by reference in its entirety.

### BACKGROUND

### Technical Field

The embodiments herein are generally related to a system and a method for displaying visual content and in particular to a visual content display system and method for displaying visually informative content remotely received over a network.

### Description of the Related Art

With the advent of globalization, the number of products and services being offered to the consumers have been increased, and substantial interest has been given to technical informative or advertising systems and methods for advertising such products and services. In this regard, a wide variety of advertising displays and promotional materials have been created and distributed to potential consumers. The conventional advertising system and method on digital signage have been commonly available in most of the public spaces of the urban area.

Further, for many organizations, operating costs are high and alternatives to increase revenue are limited. In order to increase the revenue, the organizations allow external advertisers to market their products or services through televisions or monitors installed within a campus of the organization. Employees are being shown in advertisements displayed on the television or monitor. In this scenario, the organizations do not have any control over the content presented by the advertisers.

Thus the existing information or advertisement display systems are not effective for partnering with other companies to advertise to one's employees in an office setting. In addition, there are also lost opportunities within an office when it comes to communicating with staff regarding company information, staff announcements, and emergency announcements. Therefore, there is a need for a system and method for enabling the circulation of desired visual content over a network.

The above-mentioned shortcomings, disadvantages, and problems are addressed herein and will be understood by reading and studying the following specification.

### OBJECTIVES OF THE EMBODIMENTS HEREIN

A primary object of the embodiments herein is to provide a visual content display system and method for displaying visually informative content remotely received over a network.

Another object of the embodiments herein is to provide a visual content display system and method to facilitate the organizations to increase revenue by offering exclusive advertising to their employees and/or customers.

Yet another object of the embodiments herein is to provide a visual content display system and method that enables the organizations to issue organization-wide notices, meeting announcements, weather alerts events, etc. in real-time.

Yet another object of the embodiments herein is to provide a visual content display system and method for responsive targeted advertising.

Yet another object of the embodiments herein to provide a visual content display system and method to present video, still photos, or a powerpoint presentation that can be controlled from a remote location.

These and other objects and advantages of the embodiments herein will become readily apparent from the following detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The embodiments herein provide a visual content display system and method for displaying visually informative content remotely received over a network.

According to one embodiment herein, a visual content display system includes a display device, a database, a server, and a controller. The display device is configured to display visual content. The display device includes a wireless transceiver and universal mounting hardware. The wireless transceiver is configured to establish a communication with a network to display the visual content received from one or more electronic devices operably connected over the network. The universal mounting hardware is attached at a rear portion of the wireless transceiver and configured to secure the display device to one or more objects. According to an embodiment herein, the objects are selected from at least one of an appliance, a wall, a table, and a combination thereof. The database is in operable communication with the display device to store data pertaining to the visual content. The server is configured in operable communication with the display device to provide information pertaining to the visual content in response to a request received from a user over the network. The controller provides the data pertaining to the visual content to the server from the database. The server provides the visual content information to be displayed through the display device over the network.

According to one embodiment herein, the server provides to the database a usage log of the visual content served to the display device over a time frame.

According to one embodiment herein, the display device includes a speaker operable to output sounds associated with the visual content.

According to one embodiment herein, the display device includes a camera operable to remotely monitor premises in which the display device is placed.

According to one embodiment herein, the display device is placed outdoors.

According to one embodiment herein, the display device is placed indoors.

According to one embodiment herein, the server is operable to associate the visual content with a display time.

According to one embodiment herein, the display device includes at least one of a plasma screen, a nano-display screen, a liquid crystal display (LCD) screen, a light-emitting-diode (LED) display screen, a field-emission display (FED) screen, and a flat panel display (FPD) screen.

According to one embodiment herein, the visual content is selected from at least one of advertising content, promotional content, emergency notification content, contextual content, surveillance content, organizational content, announcement content, weather notification content and a combination thereof.

According to an embodiment herein, a method of displaying visual content includes a step of establishing a communication between a wireless transceiver and one or more electronic devices. The wireless transceiver is configured to receive the visual content over the network for displaying the visual content on a display device. The method includes the step of securing the display device to one or more objects through a universal mounting hardware attached at a rear portion of the wireless transceiver. The method includes the step of storing data pertaining to the visual content received from the electronic devices in a database. The method includes the step of providing information pertaining to the visual content in response to a request received from a user based on the data stored in the database through a server. The method includes the step of providing the data pertaining to the visual content to the server from the database through a controller. The server provides the visual content information to be displayed through the display device over the network. The method includes the step of providing a usage log of the visual content served to the display device to the database over a time frame through the server.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

### BRIEF DESCRIPTION OF THE DRAWINGS

The other objects, features, and advantages will occur to those skilled in the art from the following description of the preferred embodiment and the accompanying drawings in which:

FIG. 1 illustrates a block diagram of the present visual content display system, according to an embodiment herein;

FIG. 2 illustrates a flowchart of the method of displaying visual content, according to an embodiment herein;

FIG. 3 illustrates a perspective view of the display device, according to an embodiment herein;

FIG. 4 illustrates a perspective view of the display device of an embodiment of the visual content display system while disposed on a printer, according to an embodiment herein; and

FIG. 5 illustrates a perspective view of the display device of an embodiment of the visual content display system while disposed on a computer, according to an embodiment herein.

Although the specific features of the present invention are shown in some drawings and not in others. This is done for convenience only as each feature may be combined with any or all of the other features in accordance with the present invention.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The various embodiments of the present invention provide a visual content display system and method to display the visual content in real-time over the network.

The embodiments herein provide a visual content display system and method, whereby the visual content display system includes one or more display devices, each having a wireless transceiver for communication with a network, such that each display device outputs a visual content from another display device or an electronic device operably connected to the network. Each display device is in communication with a controller that controls the visual content. Each display device includes universal mounting hardware for securing the display device to an appliance or other surface or object.

According to one embodiment herein, a visual content display system includes a display device, a database, a server, and a controller. The display device is configured to display visual content. The display device includes a wireless transceiver and universal mounting hardware. The wireless transceiver is configured to establish a communication with a network to display the visual content received from one or more electronic devices operably connected over the network. The universal mounting hardware is attached at a rear portion of the wireless transceiver and configured to secure the display device to one or more objects. According to an embodiment herein, the objects are selected from at least one of an appliance, a wall, a table, and a combination thereof. The database is in operable communication with the display device to store data pertaining to the visual content. The server is configured in operable communication with the display device to provide information pertaining to the visual content in response to a request received from a user over the network. The controller provides the data pertaining to the visual content to the server from the database. The server provides the visual content information to be displayed through the display device over the network.

According to one embodiment herein, the server provides to the database a usage log of the visual content served to the display device over a time frame.

According to one embodiment herein, the display device includes a speaker operable to output sounds associated with the visual content.

According to one embodiment herein, the display device includes a camera operable to remotely monitor premises in which the display device is placed.

According to one embodiment herein, the display device is placed outdoors.

According to one embodiment herein, the display device is placed indoors.

According to one embodiment herein, the server is operable to associate the visual content with a display time.

According to one embodiment herein, the display device includes at least one of a plasma screen, a nano-display screen, a liquid crystal display (LCD) screen, a light-emitting-diode (LED) display screen, a field-emission display (FED) screen, and a flat panel display (FPD) screen.

According to one embodiment herein, the visual content is selected from at least one of advertising content, promotional content, emergency notification content, contextual content, surveillance content, organizational content, announcement content, weather notification content and a combination thereof.

According to an embodiment herein, a method of displaying visual content includes a step of establishing a communication between a wireless transceiver and one or more electronic devices. The wireless transceiver is configured to receive the visual content over the network for displaying the visual content on a display device. The method includes the step of securing the display device to one or more objects through a universal mounting hardware attached at a rear portion of the wireless transceiver. The method includes the step of storing data pertaining to the visual content received from the electronic devices in a database. The method includes the step of providing information pertaining to the visual content in response to a request received from a user based on the data stored in the database through a server. The method includes the step of providing the data pertaining to the visual content to the server from the database through a controller. The server provides the visual content information to be displayed through the display device over the network. The method includes the step of providing a usage log of the visual content served to the display device to the database over a time frame through the server. The term “machine-readable storage medium” or “computer-readable storage medium” includes, but is not limited to, portable or non-portable storage devices, optical storage devices, and various other mediums capable of storing, containing, or carrying instruction(s) and/or data. A machine-readable medium includes a non-transitory medium in which data can be stored, and that does not include carrier waves and/or transitory electronic signals propagating wirelessly or over wired connections. Examples of a non-transitory medium include but are not limited to, a magnetic disk or tape, optical storage media such as compact disk (CD) or versatile digital disk (DVD), flash memory, memory or memory devices.

According to an embodiment herein, the display devices display advertising content, emergency alerts or other information.

According to an embodiment herein, the display devices display security camera footage if desired. According to an embodiment herein, the system is utilized to display advertising content across different areas of a workplace.

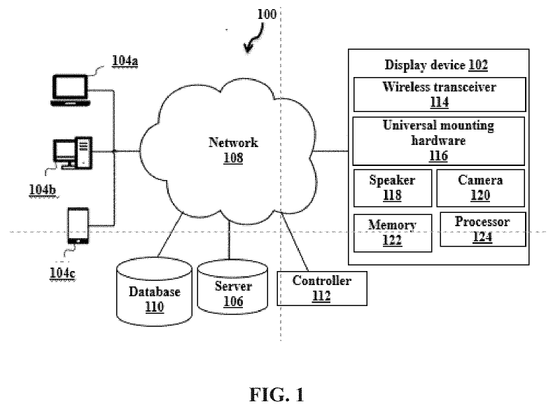

FIG. 1 illustrates a block diagram of the present visual content display system 100, according to an embodiment herein. The visual content display system 100 includes a display device 102, a database 110, a server 106, and a controller 112. The display device 102 displays visual content. Examples of the visual content including but not limited to advertising content, promotional content, emergency notification content, contextual content, surveillance content such as a security camera footage, organizational content such as a notice, or a meeting, announcement content, weather notification content, campaigns, etc. The promotional content includes one or more alterable content elements that publicize or promote a topic related to a real-world venture or real-world entity or real-world person or event.

The display device 102 includes a wireless transceiver 114 and universal mounting hardware 116. The wireless transceiver 102 establishes a communication with a network 108 to display the visual content received from one or more electronic devices 104 (for example, a laptop 104a, a desktop 104b, and a smartphone 104c) operably connected over the network 108. Other examples of electronic devices 104 include but are not limited to a phablet and a tablet. According to an embodiment herein, the network 108 is a wired or a wireless network, and the examples include but are not limited to the Internet, Wireless Local Area Network (WLAN), Wi-Fi, Long Term Evolution (LTE), Worldwide Interoperability for Microwave Access (WiMAX), and General Packet Radio Service (GPRS).

In an embodiment, the display device 102 includes a speaker 118, a camera 120, a memory 122, and a processor 124. The speaker 118 is operable to output sounds associated with the visual content. The camera 120 is operable to remotely monitor a premises in which the display device 102 is placed. The “premises” is used generically to refer to any type of building or outdoor setting in which users inhabit for any length of time, including businesses or homes.

When a user (e.g. advertiser or administrator or presenter) of laptop 104a, for example, wants to visualize the visual content, laptop 104a communicates the same with the display device 102, via network 108. According to an embodiment herein, the display device 102 presents the visual content as per the advertiser's request. According to an embodiment herein, the memory 122 locally stores the visual content or instructions pertaining to the display of the visual content. The processor 124 is configured to execute the instructions stored in the memory 122. The processor 124 is communicatively coupled to the memory 122, which is a non-volatile memory or a volatile memory. Examples of non-volatile memory include, but are not limited to flash memory, a Read Only Memory (ROM), a programmable ROM (PROM), Erasable PROM (EPROM), and Electrically EPROM (EEPROM) memory. Examples of volatile memory include but are not limited to Dynamic Random Access Memory (DRAM), and Static Random-Access memory (SRAM).

According to an embodiment herein, the processor 124 includes at least one data processor for executing program components for executing user- or system-generated requests. According to an embodiment herein, a user includes a person, a person using a device such as those included in this application, or such a device itself. According to an embodiment herein, the processor 124 includes specialized processing units such as integrated system (bus) controllers, memory management control units, floating-point units, graphics processing units, digital signal processing units, etc.

According to an embodiment herein, the Processor 124 includes a microprocessor, such as AMD® ATHLON® microprocessor, DURON® microprocessor OR OPTERON® microprocessor, ARM's application, embedded or secure processors, IBM® POWERPC®, INTEL'S CORE® processor, ITANIUM® processor, XEON® processor, CELERON® processor or other line of processors, etc. According to an embodiment herein, the processor 124 is implemented using mainframe, distributed processor, multi-core, parallel, grid, or other architectures. Some embodiments utilize embedded technologies like application-specific integrated circuits (ASICs), digital signal processors (DSPs), Field Programmable Gate Arrays (FPGAs), etc.

According to an embodiment herein, the processor 124 is disposed of in communication with one or more input/output (I/O) devices via an I/O interface. I/O interface employs communication protocols/methods such as, without limitation, audio, analog, digital, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

According to an embodiment herein, the display device 102 is placed either outdoors or indoors. In an embodiment, the display device 102 includes at least one of a plasma screen, a nano-display screen, a liquid crystal display (LCD) screen, a light-emitting-diode (LED) display screen, a field-emission display (FED) screen, and a flat panel display (FPD) screen.

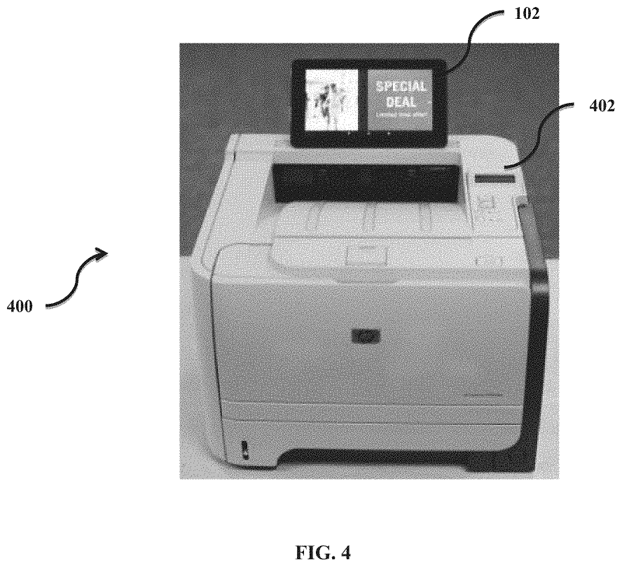

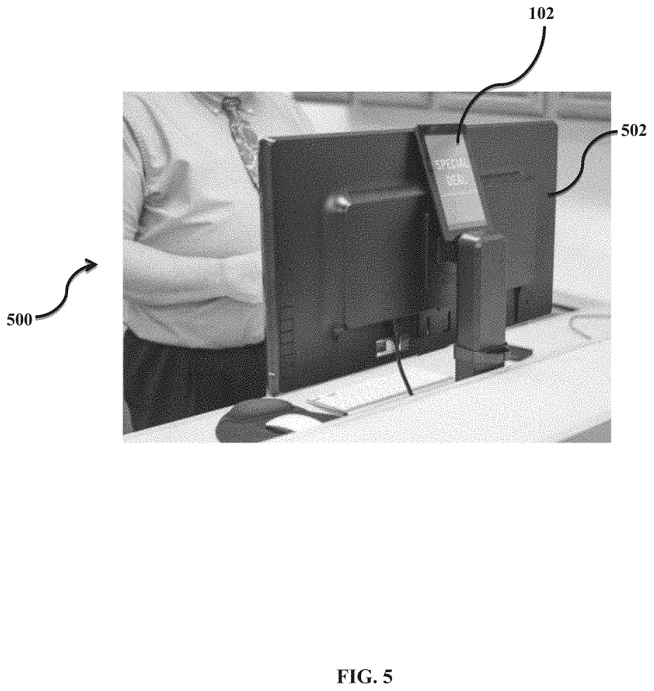

The universal mounting hardware 116 is attached at a rear portion of the wireless transceiver and configured to secure the display device to one or more objects such as an appliance, or wall, or table, or a printer or a computer (as shown in FIGS. 4-5) or other vertical/horizontal surfaces. The database 110 stores data pertaining to the visual content. In an embodiment, the database 110 is realized through various technologies such as, but not limited to, Microsoft® SQL Server, Oracle®, IBM DB2®, Microsoft Access®, PostgreSQL®, MySQL® and SQLite®, and the like.

The server 106 provides information pertaining to the visual content in response to a request received from a user over the network 108. The controller 112 provides the data pertaining to the visual content to the server 106 from the database 110. The server 106 provides the visual content information to be displayed through the display device 102 over the network 108. In an embodiment, the server 106 provides to the database a usage log of the visual content served to the display device 102 over a time frame. In an embodiment, the server 106 is operable to associate the visual content with a display time. A person with ordinary skills in the art will understand that the scope of the application is not limited to server 106 as a separate entity. In an embodiment, the functionalities of the database 110 can be integrated into the server 106.

In an embodiment, the server 106 refers to a computing device or a software framework hosting an application or a software service. In an embodiment, server 106 is be implemented to execute procedures such as, but not limited to, programs, routines, or scripts stored in one or more memories for supporting the hosted application or the software service. In an embodiment, the hosted application or the software service is configured to perform one or more predetermined operations. The server 106 is realized through various types of application servers such as, but are not limited to, a Java application server, a .NET framework application server, a Base4 application server, a PHP framework application server, or any other application server framework.

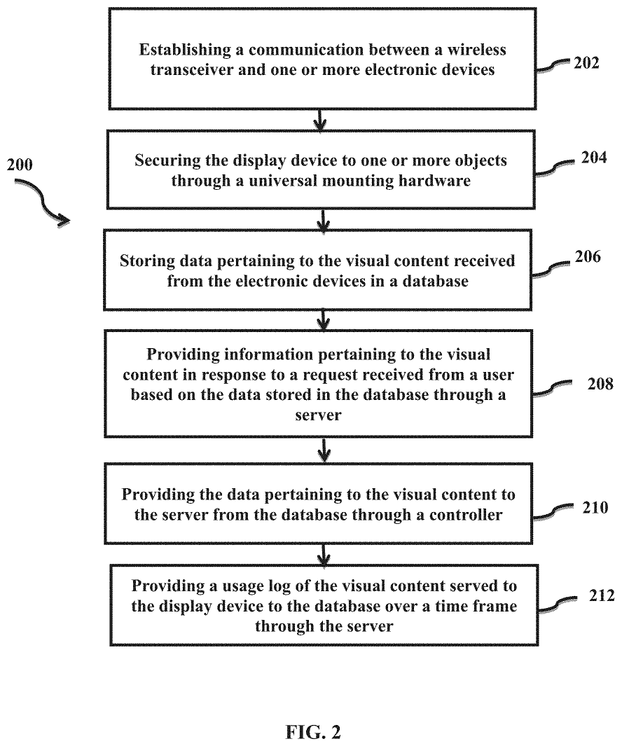

FIG. 2 illustrates a flowchart 200 of the method of displaying visual content, according to an embodiment herein. The method includes a step 202 of establishing a communication between a wireless transceiver and one or more electronic devices. The wireless transceiver is configured to receive the visual content over the network for displaying the visual content on a display device. The method includes the step 204 of securing the display device to one or more objects through universal mounting hardware attached at a rear portion of the wireless transceiver. According to an embodiment herein, the objects are selected from at least one of an appliance, a wall, a table, and a combination thereof. The method includes the step 206 of storing data pertaining to the visual content received from the electronic devices in a database. The method includes the step 208 of providing information pertaining to the visual content in response to a request received from a user based on the data stored in the database through a server. The method includes the step 210 of providing the data pertaining to the visual content to the server from the database through a controller. The server provides the visual content information to be displayed through the display device over the network. The method includes the step 212 of providing a usage log of the visual content served to the display device to the database over a time frame through the server.

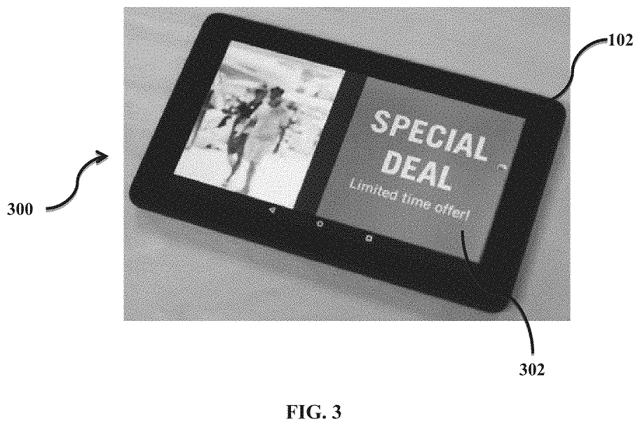

FIG. 3 illustrates a perspective view 300 of the display device 102, according to an embodiment herein. According to an embodiment herein, the display device 102 includes a User Interface (UI) 302 that is used by a user or an administrator or the advertiser to initiate a request to display the visual content. In an embodiment, the User Interface (UI or GUI) 302 is a convenient interface for accessing the information related to the visual content.

FIG. 4 illustrates a perspective view 400 of the display device 102 of an embodiment of the visual content display system while disposed on a printer 402, according to an embodiment herein. FIG. 5 illustrates a perspective view 500 of the display device 102 of an embodiment of the visual content display system while disposed on a computer 502, according to an embodiment herein. In an embodiment, one or more display devices 102 are installed in the premises of the organization. Each display device 102 is identified by an Internet Protocol address (IP address) and allows the organization to control the various display devices 102 separately. In an embodiment, the various display devices 102 are connected to the wireless network of the organization for downloading changes in scheduling advertisement runs, alerts, or other messages.

In an exemplary embodiment, the display device 102 utilizes a Raspberry IP or a custom made algorithm for downloading changes in scheduling advertisement runs, alerts, or other messages. In an embodiment, each display device 102 uses a custom “Television” network designed for the organization's preferences. Currently, many organizations are allowing advertising in their place of business without the benefits of control or benefiting financially by running “Network Television”. The present system 100 provides complete control of what is being presented to the staff or clientele of the organization.

In operation, the visual content display system 100 allows the organization to perform various steps in order to select the advertisements to be displayed. The step includes establishing a list of interested advertisers by the organization or owner of each display device 102. The list of interested advertisers can be selected in-house or by contacting an outside marketing partner. The selected advertising partners should not compete with or have a conflict with the rules or interests or policies or regulations of the organization. Further, the advertisements are reviewed and approved by the organization or owner of each display device 102 before being loaded to each display device 102 or group of display devices 102 for a scheduled time to run. Advertisements are billed according to a predetermined rate per spot agreement. Also, a marketing program can be managed either with an internal organization or working with an existing external marketing partner.

Although the embodiments herein are described with various specific embodiments, it will be obvious for a person skilled in the art to practice the embodiments herein with modifications.

The visual content display system and method for displaying visual content disclosed in the embodiments herein have several exceptional advantages over existing visual display systems. Firstly, the visual content display system and method provide an efficient, simpler and more elegant solution that combines the controller with the display device on which the advertisers flexibly target their advertisements onto their potential group of customers in real-time. Secondly, the visual content display system and method enable the organizations to issue organization-wide notices, meeting announcements, weather alerts events, etc. in real-time. Thirdly, the visual content display system and method facilitate the organizations to initiate responsive targeted advertising for their products, services, events or any social cause. Lastly, the visual content display system and method present video, still photos, or a powerpoint presentation that can be controlled from a remote location.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A visual content display system comprising:
a display device configured to display visual content, wherein the display device comprising:
a wireless transceiver configured to establish a communication with a network to display the visual content received from one or more electronic devices operably connected over the network; and
a universal mounting hardware attached at a rear portion of the wireless transceiver and configured to secure the display device to one or more objects;
a database in operable communication with the display device to store data pertaining to the visual content;
a server configured in operable communication with the display device to provide information pertaining to the visual content in response to a request received from a user over the network; and
a controller configured to provide the data pertaining to the visual content to the server from the database, wherein the server provides the visual content information to be displayed through the display device over the network.

2. The visual content display system according to claim 1, wherein the server provides to the database a usage log of the visual content served to the display device over a time frame.

3. The visual content display system according to claim 1, wherein the display device comprises a speaker operable to output sounds associated with the visual content.

4. The visual content display system according to claim 1, wherein the display device comprises a camera operable to remotely monitor a premises in which the display device is placed.

5. The visual content display system according to claim 1, wherein the display device is placed outdoors.

6. The visual content display system according to claim 1, wherein the display device is placed indoors.

7. The visual content display system according to claim 1, wherein the server is operable to associate the visual content with a display time.

8. The visual content display system according to claim 1, wherein the display device comprises at least one of a plasma screen, a nano-display screen, a liquid crystal display (LCD) screen, a light-emitting-diode (LED) display screen, a field-emission display (FED) screen, and a flat panel display (FPD) screen.

9. The visual content display system according to claim 1, wherein the visual content is selected from at least one of advertising content, promotional content, emergency notification content, contextual content, surveillance content, organizational content, announcement content, weather notification content and a combination thereof.

10. The visual content display system according to claim 1, wherein the objects are selected from at least one of an appliance, a wall, a table, and a combination thereof.

11. A method of displaying visual content, the method comprising the steps of:
establishing a communication between a wireless transceiver and one or more electronic devices, wherein the wireless transceiver is configured to receive the visual content over the network for displaying the visual content on a display device;
securing the display device to one or more objects through a universal mounting hardware attached at a rear portion of the wireless transceiver;
storing data pertaining to the visual content received from the electronic devices in a database;
providing information pertaining to the visual content in response to a request received from a user based on the data stored in the database through a server; and
providing the data pertaining to the visual content to the server from the database through a controller, wherein the server provides the visual content information to be displayed through the display device over the network.

12. The method according to claim 11 comprises the step of providing a usage log of the visual content served to the display device to the database over a time frame through the server.

13. The method according to claim 11, wherein the display device comprises a speaker operable to output sounds associated with the visual content.

14. The method according to claim 11, wherein the display device comprises a camera operable to remotely monitor a premises in which the display device is placed.

15. The method according to claim 11, wherein the display device is placed outdoors.

16. The method according to claim 11, wherein the display device is placed indoors.

17. The method according to claim 11, wherein the server is operable to associate the visual content with a display time.

18. The method according to claim 11, wherein the display device comprises at least one of a plasma screen, a nano-display screen, a liquid crystal display (LCD) screen, a light-emitting-diode (LED) display screen, a field-emission display (FED) screen, and a flat panel display (FPD) screen.

19. The method according to claim 11, wherein the visual content is selected from at least one of advertising content, promotional content, emergency notification content, contextual content, surveillance content, organizational content, announcement content, weather notification content and a combination thereof

20. The method according to claim 11, wherein the objects are selected from at least one of an appliance, a wall, a table, and a combination thereof.
